(19) United States
(12) Patent Application Publication
(10) Pub. No.: US 2010/0154033 A1
(43) Pub. Date: Jun. 17, 2010

(54) METHOD AND NODES FOR SECURING A COMMUNICATION NETWORK

(75) Inventor: Desire Oulai, Longueuil (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/335,703

(22) Filed: Dec. 16, 2008

(51) Int. Cl. G06F 21/00

(52) U.S. Cl. 726/3

(57) ABSTRACT

Methods for securing a communication network comprise the steps of: (in a first node) applying at least one security mechanism to a data packet; and setting a security indicator in the data packet upon application of the at least one security mechanism to the data packet; (in a second node) receiving the data packet; determining if a security indicator is present in the received data packet; applying at least one security mechanism to the received data packet upon determining that the security indicator is not present; and refraining from applying security to the received data packet upon determining that the security indicator is present. A mobile node and access node for securing the communication network, comprise respectively a security application module and a security module, and, an input for receiving a data packet; a security detector and a security application module responsive to the security detector.

### TECHNICAL FIELD

The present invention generally relates to communication networks. More specifically, the present invention is concerned with a method and nodes for securing such communication networks.

### BACKGROUND

Over the past few decades, telecommunications and Internet have experienced an incredible growth and expansion. Technologies have changed from centralized computing to personalized computing and now to mobile computing with a convergence of networks, devices and services.

Mobile computing is made possible through the use of Mobile IP or more specifically Mobile IPv6 (MIPv6), using the version 6 of Internet Protocol (IP). Mobile IPv6 (MIPv6) is an Internet Engineering Task Force (IETF) standard communication protocol. It has been designed to allow mobile users to move from one network to another without experiencing discontinuity of services. Indeed, MIPv6 protocol provides for continuous IP services to a mobile node (MN), the mobile node being a mobile phone, a laptop or PDA, etc., by maintaining connectivity of the MN with the different networks.

The mobility services are deployed through a Home Agent (HA) which provides a Home Address (HoA) to a MN registered with that HA. When the MN moves away and attaches itself to a different access router, it acquires a new address, called the Care-Of Address (CoA). The MN then sends a Binding Update (BU) to the HA in order to bind the CoA to the HoA, so that traffic directed to the HoA is forwarded to the CoA. The HA replies back to the MN with a Binding Acknowledgement (BA) and forwards each data packet with HoA as destination address to the CoA using a bidirectional tunnel, for example. By so doing, the mobile node (MN) is able to move without ending ongoing sessions as the HoA of the MN remains unchanged.

However, there still exist mobile hosts that have not implemented MIPv6, for reasons such as they do not want to or they cannot. For those hosts, a proxy version, called PMIP, has been developed. When using IPv6, the proxy mobile IP is referred to as PMIPv6.

PMIP has been designed for local mobility handling. The MN is connected to a Mobile Access Gateway (MAG) using a layer 2 access technology, for example. The MAG is responsible for managing the mobility on behalf of the MN. In a PMIP domain, a Local Mobility Anchor (LMA) is also defined for distributing the Home Network prefixes (or addresses) and hiding the mobility from the external world, i.e. outside of the PMIP domain. The binding is performed by the MAG using a Proxy BU (PBU) and the LMA responds back with a Proxy BA (PBA). When moving into the PMIP domain, the concept of CoA is replaced by a Proxy CoA (PCoA), which is the address of the MAG with which the MN is registered. Once the binding is completed, data packets are tunneled between the LMA and the MAG.

MIP offers global mobility and PMIP offers local mobility. More specifically, PMIP provides for network-based mobility management in the PMIP domain, i.e. the MAG manages the mobility on behalf of the MN. For this reason, it is common to see service operators using and deploying such PMIP domains.

Also, a current typical architecture consists of running MIP on top of PMIP so as to form a nested MIP/PMIP architecture.

However, this current nested MIP/PMIP architecture generally presents a drawback concerning the security or protection applied to data packets exchanged between different connections. Indeed, a first security level, using for example IPsec ESP, can be applied in the connection session between the MN and a correspondent node (CN). A second security level can be then applied in the MIP tunneling between the MN and the HA. Finally, a third security level can be applied using also, for example, IPsec ESP in the PMIP tunneling between the MAG and the LMA. In this case, different levels of security are redundant (e.g., the second and third in the above example) and can generally cause delays and/or undue processing during data packet transfers. A similar problem can be expected in other examples of nested architecture where a security mechanism is present on a path encompassed within a more global path in which the second security mechanism is also present.

Therefore, it would be interesting to overcome the above-discussed problem, related to redundant security levels in data packets traveling in a nested architecture.

### SUMMARY

More specifically, in accordance with a first aspect of the present invention, there is provided a method for securing a communication network. The method comprises the steps of: applying at least one security mechanism to a data packet; and setting a security indicator in the data packet upon application of the at least one security mechanism to the data packet.

According to a second aspect of the present invention, there is provided a mobile node for securing a communication network. The mobile node comprises a security application module so configured as to apply at least one security mechanism to a data packet; and a security module for setting a security indicator in the data packet for indicating application of the at least one security mechanism to the data packet.

According to a third aspect of the present invention, there is provided a method for securing a communication network. The method comprises the steps of: receiving a data packet; determining if a security indicator is present in the received data packet; applying at least one security mechanism to the received data packet upon determining that the security indicator is not present; and refraining from applying security to the received data packet upon determining that the security indicator is present.

According to a fourth aspect of the present invention, there is provided an access node for securing a communication network. The access node comprises: an input for receiving a data packet; a security detector so configured as to detect a security indicator in the received data packet; and a security application module responsive to the security detector for applying security to the received data packet upon detecting absence of the security indicator and for refraining from applying security in the received data packet upon detection of the security indicator.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of a nested network architecture;

FIG. 2 illustrates an example of data packets encapsulated for the tunnel between an access node and a network node;

FIG. 3 illustrates an example of data packets encapsulated for the tunnel between an access node and a network node with a security notification option or indicator according to a non-restrictive illustrative embodiment of the present invention;

FIG. 4 illustrates a flow chart of a method for securing a communication network, such as the nested network architecture of FIG. 1, according to a non-restrictive illustrative embodiment of the present invention;

FIG. 5 is a schematic block diagram of a mobile node in accordance with a non-restrictive illustrative embodiment of the present invention; and

FIG. 6 is a schematic block diagram of an access node in accordance with a non-restrictive illustrative embodiment of the present invention.

### DETAILED DESCRIPTION

Before going into the description of the non-restrictive illustrative embodiment of the present invention, it should be noted that the term MIP (or PMIP in the proxy case) can be used interchangeably with the term MIPv6 (or PMIPv6) without departing from the scope and nature of the present invention.

Even though the following description will be given within the context of a nested MIP/PMIP network architecture, it should be understood that the MIP/PMIP architecture represents only an example of nested architectures, having for example a first domain nested with a second domain, wherein the first domain includes the MIP domain and the second domain includes the PMIP domain in the case of nested MIP/PMIP architectures. Embodiments of the present invention can be applied to other nested architectures and communication networks.

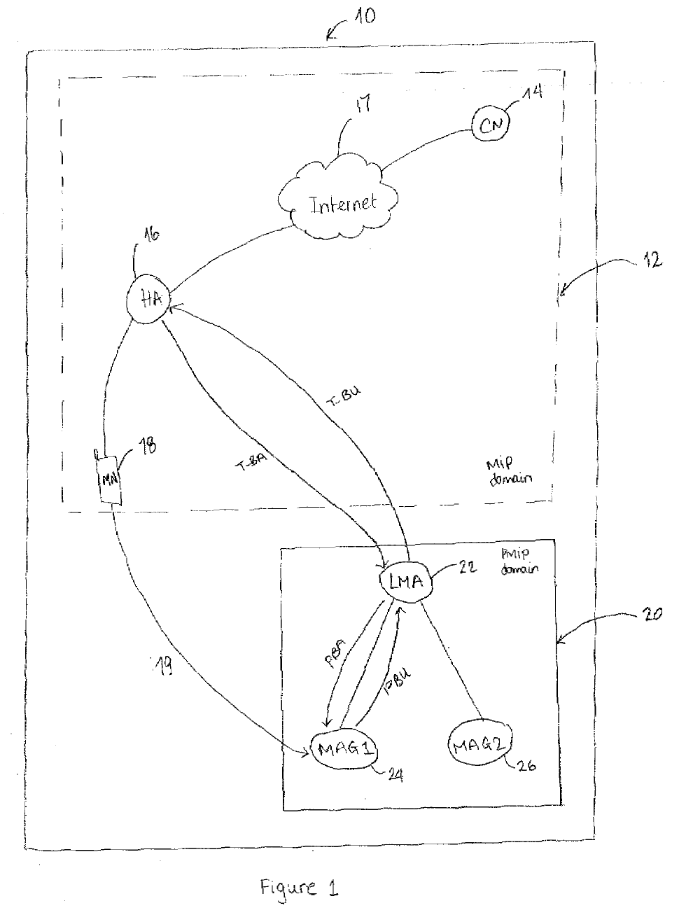

As mentioned hereinabove, PMIP is designed for local mobility handling and MIP is more suitable for global mobility. Accordingly, as shown in FIG. 1, a nested network architecture, and more specifically a nested MIP/PMIP architecture 10 has a MIP domain 12 running on top of a PMIP domain 20.

The nested MIP/PMIP architecture 10 will be now described with reference to FIG. 1.

The MIP domain 12 includes, for example, a correspondent node (CN) 14, connected to Internet 17 and a HA 16, in which the MN 18 is initially registered.

The PMIP domain 20 includes a LMA 22, which is connected to a MAG1 24 and MAG2 26. It should be noted that the LMA 22 can be connected to a plurality of MAGs, it is not restricted only to two (2) MAGs as shown in FIG. 1. The LMA 22 can be a network node, which manages the connectivity between the PMIP domain 20 and the MIP domain 12. And the MAGs can be access nodes, to which the MN 18 can get attached.

More specifically, in this architecture 10, the MN 18 manages the global mobility, i.e. the MN 18 makes sure that the HA 16 is made aware of ways how to reach the MN 18 and the MAGs manage local mobility in the PMIP domain 20. Furthermore, the nested PMIP/MIP architecture 10 can include more than one PMIP domain 20.

During a communication session between the CN 14 and the MN 18, which is in displacement, for example the MN 18 moves from the MIP domain 12 to the PMIP domain 20, as shown by the arrow 19 in FIG. 1, the data packets exchanged between the CN 14 and the MN 18 will go through three (3) levels of security associated with each encapsulation. First, the data packets are encapsulated for the connection between the CN 14 and the MN 18, then they are encapsulated in the MIP tunnel between the MN 18 and HA 16, and finally, they are encapsulated in the PMIP tunnel between the MAG 24 and the LMA 22. In each encapsulation, a security mechanism, such as encryption, is applied to the data packets for protection purposes. The same kind of security mechanism as well as other security mechanisms can be applied to the different encapsulated data packets.

As an implementation example, the security levels can be provided by IPsec. Of course, other technologies, well known in the art, can be used as well, such as Network Layer Security Protocol (NLSP), SSL, TLS, etc.

In the case IPsec is applied to the data packets for a communication session between the CN 14 and the MN 18, when the MN 18 moves into the PMIP domain 20 and attaches itself to the MAG1 24, the MAG1 24 will generally not be able to detect if the data packets have been previously protected by a security mechanism. For that reason, another security level will be applied to the data packets in the tunnel between the MAG1 24 and the LMA 22.

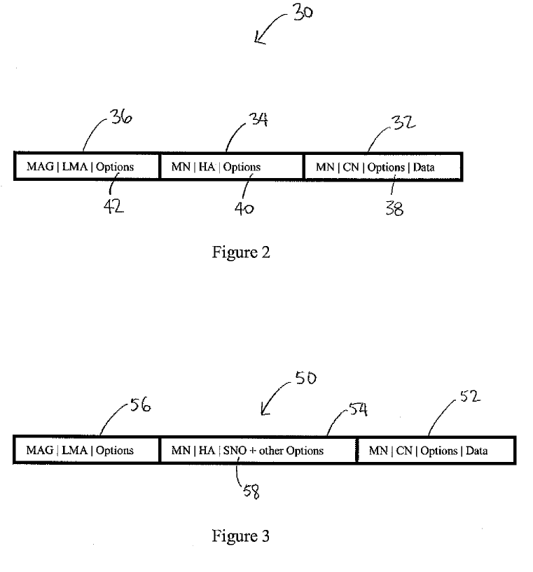

More specifically, FIG. 2 shows an example of encapsulation of the data packets 30 exchanged between an access node, such as the MAG1 24 and a network node, for example the LMA 22. The data packets 30 comprise three nested encapsulations: 1) a first encapsulation 32 between the MN 18 and the CN 14, 2) a second encapsulation 34 between the MN 18 and the HA 16, and 3) a third encapsulation 36 between the MAG1 24 and the LMA 22. In each encapsulation, 32, 34, and 36, an option field (respectively 38, 40, and 42) is available for including additional parameters and options. Security is generally applied in each encapsulation because subsequent encapsulations, such as 36, cannot detect previously applied security in encapsulation 34, for example. This leads to redundancy of security.

Furthermore, because of the encapsulation 40 between the MN 18 and the HA 16 of the data packets 30, the MAG1 24 cannot differentiate the individual flows when receiving these encapsulated data packets.

Therefore, as generally stated, a non-restrictive illustrative embodiment of the present invention allows for providing an indicator of security applied in a prior encapsulation. By so doing, security redundancy is eliminated, and thereby delays and/or additional processing incurred during data transfers can for example be reduced, especially in cases where encryption is the security mechanism used to protect the data packets, the encryption generally being time and resource consuming. The non-restrictive illustrative embodiment of the present invention will be explained in the context of the nested MIP/PMIP architecture 10 of FIG. 1. However, it should be understood that it can be extended to any communication networks and more specifically to any scenarios where nested tunnels or connections are involved. A nested connection can be defined as a connection involved between a domain which runs on top of another one or vice-versa, the two domains forming a nested network.

Now, turning to FIG. 3, the non-restrictive illustrative embodiment of the present invention will be described in the context of the MIP/PMIP architecture 10.

Data packets 50 are successively encapsulated, between the MN 18 and CN 14 (encapsulation 52), for the tunnel between the MN 18 and HA 16 (encapsulation 54) and for the tunnel between the MAG1 24 and the LMA 22 (encapsulation 56).

Suppose that security is applied in encapsulation 52 between the MN 18 and the CN 14, using IPsec for example. In that case, in encapsulation 54 between the MN 18 and the HA 16, the MN 18 will add or set a security indicator 58, called, for instance, a Security Notification Option (SNO). This SNO can be implemented by using a new IPv6 extension option in the IPv6 header of the data packets. Of course, it should be understood that the indicator SNO can be implemented using other ways as well, such as using a tag for Ethernet. Alternatively, similar results could be obtained by having the security indicator 58 transmitted in a further communication, for example in a further packet such as a signaling packet, which is sent before or during a communication session and which includes a way of identifying a packet stream (e.g., a session identifier or port+destination address). In that case, a network node receiving the packet containing the security indicator 58 is informed that the incoming packet stream has already security applied to it and thus does not need additional security. Optionally if more than one security mechanisms have been applied to the packet stream, an identifier for each of the security mechanisms being applied (either in text, standardized value, set of flag(s), etc.) can be provided.

Now, suppose that security was not applied in encapsulation 52 between the MN 18 and the CN 14. In that case, in encapsulation 54 between the MN 18 and the HA 16, the MN 18 can decide to apply security to the data packets. Then, the MN 18 can add the security indicator 58 in encapsulation 54.

The security indicator 58 given by the SNO will inform the MAG1 24 in encapsulation 56 that security is already in place, provided by a previous encapsulation for example, for the current flow or data packets. Therefore, in encapsulation 56, there is no need of applying another security level to the current flow or data packets. Using such an indicator, security redundancy can be eliminated.

More specifically, an example of the security indicator 58, such as the SNO, is shown as follows:

| Next Header | Hdr Ext Len | Option Type | Opt Data Len |
|---|---|---|---|
| A | I | E | Reserved |

It should be noted that the first four (4) bytes of the indicator SNO (see the first row above) are similar to those in the IPv6 headers except for the fields “Option Type” and “Option Data Length”. The field “Option Type” should be assigned and the field “Option Data Length” is four (4) byte-long. The indicator SNO is not limited to those fields and can have additional fields for supporting different options.

Furthermore, the security indicator 58 or SNO can also specify and/or indicate which particular security mechanisms have been applied to the data packets by using some specific fields, such as “A”, “I” and “E”. Each one of those fields can be defined by a bit for example.

The “A” field is concerned with authentication. If the “A” field of the indicator SNO is set to one (1), then it means that its data in the payload are authenticated.

The “I” field is concerned with the integrity of the content of the received data packets. If the “I” field is set to one (1), then it means that its data in the payload has content integrity.

And the “E” field is concerned with encryption. If the “E” field is set to one (1), then it means that its data in the payload are encrypted.

If the different above-mentioned security mechanisms are absent, i.e. they were not applied to the data packets, then, the different fields “A”, “I” and “E” are set to zero (0). Of course, other values, besides one (1) and zero (0) can be used depending on the implementation of the specific fields “A”, “I” and “E” of the indicator SNO.

Therefore, depending on the values of the fields “A”, “I”, and “E”, the nodes (MAG1 24, MAG2 26 and LMA 22) in the PMIP domain 20 can decide whether to apply additional security or not and/or which type of security mechanisms to apply so as to control application of security in the data packets and avoid security redundancy.

Furthermore, the SNO can comprise a reserved field, for a particular or future use or for providing additional security options.

In the above non-restrictive example, the SNO has been described in relation to IPv6, however, it should be understood that such a security indicator can be deployed in other contexts and environments, using different formats and specifying other security details. For example, the security indicator 58 can be used to indicate a type of security applied to the data packets per category; this information can be understood by the nodes receiving the data packets. Also, this information, carried by the security indicator 58, can be given by more than a bit, so as to extend over a few bytes. In that case, for instance, if the data packets are secured through encryption, the nature of the encryption can be provided, i.e. encryption using RSA-256 or RSA-1024, etc. Similarly, different types of authentication mechanisms can be indicated, i.e. authentication using Kerberos, Radius, etc, and different ways of performing integrity protection mechanisms can be provided as well, such as checksum or hashing.

It should be noted that additional fields related to other security mechanisms can be added into the security indicator 58, i.e. it is not limited only to the three (3) above-mentioned security mechanisms.

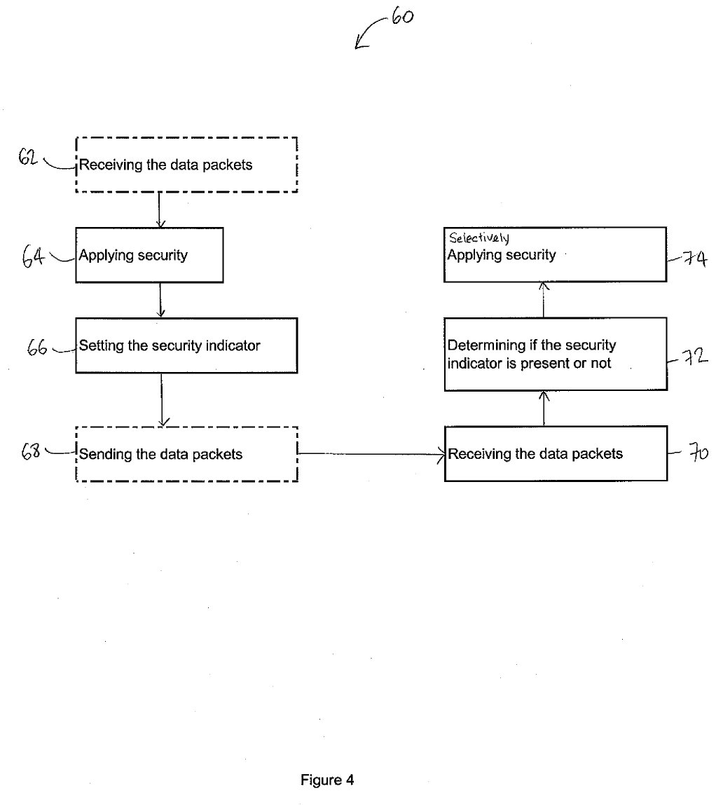

A method for securing a communication network according to a non-restrictive illustrative embodiment of the present invention is summarized in FIG. 4.

Now, turning to FIG. 4, the method 60 for securing a communication network, such as the nested MIP/PMIP architecture 10 of FIG. 1, will be described. It should be noted that steps given by the dashed boxes refer to some optional steps in the method 60.

In step 62, data packets encapsulated for a first nested connection, such as the communication session between the MN 18 and CN 14, are received from the application layer in the MN 18. Similarly, for a communication session transiting through or initiated from the HA 16 towards the MN 18, the HA 16 could receive data packets from an application layer, which come from the CN 14 or other nodes trying to communicate with the MN 18. In the following steps, the MN 18 and the HA 16 can assume the same functions in the non-restrictive illustrative embodiment of the present invention, therefore operations described for the MN 18 can be also applied to the HA 16. In the same way, in the tunnel established between the MAG1 24 and the LMA 22, the MAG1 24 and the LMA 22 can assume the same functions and the operations described for the MAG1 24 can be also applied to the LMA 22. Furthermore, it can be assumed that the communication network 10 has a first and second network nodes communicating with each other, the first network node corresponding to the MN 18 or the HA 16 and the second network node corresponding to the MAG1 24 or the LMA 22.

In step 64, the MN 18 or HA 16 applies security in the received data packets in the TCP/IP layer for the tunnel between the MN 18 and the HA 16, for example. More specifically, the MN 18 or HA 16 can apply one or more security mechanisms to the data packets among authentication, encryption and integrity protection. The choice of applying a particular security mechanism can depend on the type or QoS of applications or services of the data packets.

In step 66, upon application of the security mechanisms, the MN 18 (or the first network node) adds a security indicator 58 or sets the security indicator 58 if it has been added in a prior encapsulation. The security indicator 58 can be the SNO implemented in the IP header of the received data packets for example.

In the case where the MN 18 adds the security indicator 58, it can also set the security mechanism fields, “A”, “I” and “E”, according to the one or more security mechanisms which have been applied to the data packets. For example, if only encryption was applied to the data packets, then the security indicator 58 would have the following fields: A=0, I=0 and E=1. If all the three (3) mechanisms were applied, then the security indicator 58 would have the following fields: A=1, I=1 and E=1.

In the case where the security indicator 58 has been already added in a prior encapsulation from a previous connection, meaning that security has been previously applied, the MN 18 needs only to set the security indicator 58. The MN 18 can also determine which particular security mechanisms have been previously applied, by reading the different fields of the security indicator 58 for example. The MN 18 can then decide to apply additional security mechanisms to the received data packets, other than the already applied security mechanisms. If so, the MN 18 then sets the remaining fields of the security indicator 58 to one (1), corresponding to the additional security mechanisms which were applied.

It should be noted that the order of operations between setting the security indicator 58 and applying the security mechanisms in the received data packets for the current encapsulation (for the tunnel between the MN 18 and the HA 16, for example) does not matter, as long as the security mechanisms are applied in the current encapsulation. Indeed, in an alternative embodiment of the present invention, after receiving the data packets (e.g., from the application layer in the MN 18), the MN 18 can first set the security indicator 58 and then apply the corresponding security mechanisms to the data packets.

It should be noted that once the security indicator 58 is added, it can be set for any other subsequent connections involved in the nested network architecture 10, therefore, there is no need for the subsequent connections to add security in the data packets.

In step 68, the data packets are transmitted from the MN 18 over a nested connection to the access node, such as the MAG1 24, for the tunnel between the MAG1 24 and the LMA 22, the tunnel being established according to known procedures in the art. Data packets can also be sent from the HA 16 over a nested connection towards the MN 18 via the LMA 22.

In step 70, the MAG1 24 receives the data packets coming from the MN 18 or the LMA 22 receives the data packets coming from the HA 16.

In step 72, the MAG1 24 determines if the security indicator 58 is present or not in the received data packets sent from the MN 18. Alternatively, if the data packets are coming from the HA 16, the LMA 22 determines if the security indicator 58 is present or not in the received data packets.

Upon detecting the presence of the security indicator 58, in step 74 the MAG1 24 or the LMA 22 (i.e. the second network node) then decides to refrain from applying another security level to the data packets, in order to avoid having security redundancy. Furthermore, upon reading the values of the fields “A”, “I” and “E”, and in the case where not all the three (3) fields are set to one (1), the MAG1 24 or LMA 22 can decide to apply the security mechanism(s) corresponding to the field(s) which was (were) not set to one (1). This operation can be optional however.

In the case where the MAG1 24 or LMA 22 detects no security indicator 58 in the received data packets, meaning that no security has been previously applied for the tunnel between the MN 18 and the HA 16, for example, the MAG1 24 or LMA 22 decides to apply a security level to the received data packets for the tunnel between the LMA 22 and the MAG1 24, still in step 74.

By using such a security indicator, the data packets are always protected but there is also a means provided for avoiding redundancy of security application.

As mentioned hereinabove, IPsec can be used by the access node, such as the MAG1 24, for applying the security level.

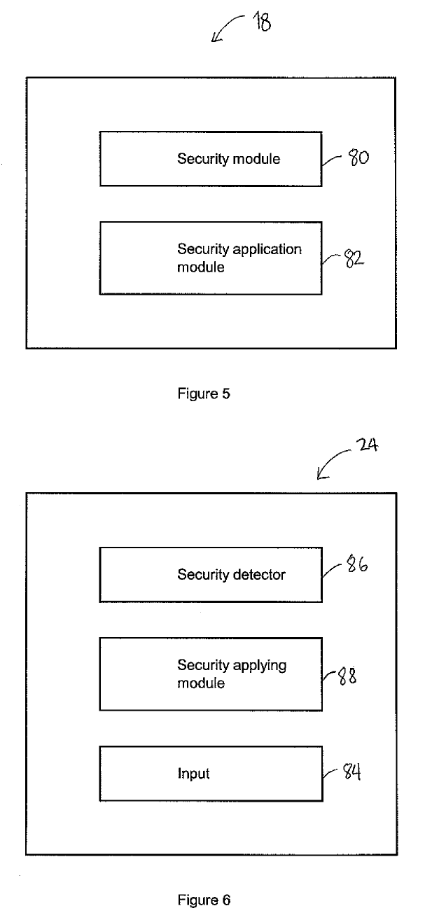

FIG. 5 shows a schematic view of the first network node in the communication network 10, such as the mobile node 18 or the HA 16 and FIG. 6 shows a schematic view of the second network node such as the MAG1 24 or LMA 22, for carrying out the method 60 as described above

Now, referring to FIG. 5, the firs network node, e.g. the mobile node 18, will be described.

The mobile 18 has a security module 80 and a security application module 82.

Of course the mobile node 18 also comprises a plurality of other components (not shown), such as a receiving module for receiving data packets from the application layer in the MN 18, an output for sending the data packets to the next connection, a processor or memory, for performing its usual tasks and procedures, which are well known in the art and thus will not be described further.

Upon receiving the data packets through the receiving module, the MN 18 uses the security application module 82 to apply security in the received data packets, before they are sent to the next connection.

Before the data packets are sent to the next connection, the MN 18 also uses the security module 80 for adding or setting the security indicator 58, such as the SNO to the data packets, so as to indicate to the next connection that security has been already in place, therefore the next connection does not need to apply another level of security.

Furthermore, the security module 80 can set the different security mechanism fields, such as “A”, “I” and “E”, of the security indicator 58 to the value of one (1) for example. A security mechanism field is set to one (1) when the security mechanism corresponding to that field is applied by the security application module 82 to the received data packets.

Now turning to FIG. 6, the second network node, e.g. the access node, such as the MAG1 24, will be described.

The access node has an input 84, a security detector 86 and a security applying module 88.

Of course the access node also comprises a plurality of other components (not shown), such as a processor or memory, for performing its usual tasks and procedures, which are well known in the art and thus will not be described further.

The access node receives the data packets, sent from the MN 18 for example, through the input 84.

Upon receiving the data packets, the access node uses the security detector 86 for detecting the presence of the security indicator 58 in the data packets.

If the security indicator 58 is detected, the security applying module 88 then refrains from applying a security level, so as to prevent security redundancy.

If the security indicator 58 is not detected, meaning that the security indicator 58 is absent, then the security applying module 88 applies at least one security mechanism to the received data packets.

It should be noted that the security indicator 58 can be added or set to data packets whose content can be any information, such as voice data, video, control or signaling messages, etc.

Although the present invention has been described in the foregoing specification by means of a non-restrictive illustrative embodiment, this illustrative embodiment can be modified at will within the scope, and nature of the subject invention.

1. A method for securing a communication network, the method comprising the steps of:
applying at least one security mechanism to a data packet; and
setting a security indicator in the data packet upon application of the at least one security mechanism to the data packet.

2. A method as defined in claim 1, wherein applying the at least one security mechanism comprises applying at least one of authentication, integrity protection and encryption to the data packet.

3. A method as defined in claim 1, wherein setting the security indicator comprises a preliminary step of adding the security indicator.

4. A method as defined in claim 1, wherein setting the security indicator comprises adding an IPv6 extension option in a header of the data packet.

5. A method as defined in claim 1, wherein setting the security indicator comprises setting a plurality of values, wherein each of a plurality of security mechanisms corresponds to one of the plurality of values.

6. A method as defined in claim 5, wherein setting the security indicator further comprises setting at least one of the plurality of values in accordance with the step of applying at least one security mechanism to the data packet.

7. A method as defined in claim 6, further comprising transmitting the data packet with the set security indicator to a next node via a nested connection.

8. A method as defined in claim 7, wherein, upon receiving the data packet with the set security indicator, the next node refrains from applying security to the received data packet so as to prevent redundant security applications.

9. A method as defined in claim 7, wherein, upon receiving the data packet with the set security indicator, the next node applies additional security mechanisms other than the at least one security mechanism applied in the received data packet.

10. A first network node for securing a communication network, the first network node comprising:
a security application module so configured as to apply at least one security mechanism to a data packet; and
a security module for setting a security indicator in the data packet for indicating application of the at least one security mechanism to the data packet.

11. A first network node as defined in claim 10, wherein the security application module is so configured as to apply at least one of authentication, integrity protection and encryption to the data packet.

12. A first network node as defined in claim 10, wherein the security module adds the security indicator to the data packet prior to setting the security indicator.

13. A first network node as defined in claim 10, wherein the security indicator comprises an IPv6 extension option.

14. A first network node as defined in claim 10, wherein the security indicator comprises a plurality of values, wherein each of a plurality of security mechanisms corresponds to one of the plurality of values.

15. A first network node as defined in claim 14, wherein the security module sets at least one of the plurality of values in accordance with the at least one security mechanism applied to the data packet by the security application module.

16. A first network node as defined in claim 10, further comprising an output for transmitting the data packet with the set security indicator to a next node via a nested connection.

17. A first network node as defined in claim 16, wherein, upon receiving the data packet with the set security indicator, the next node refrains from applying security to the received data packet so as to prevent redundant security applications.

18. A first network node as defined in claim 16, wherein, upon receiving the data packet with the set security indicator, the next node applies additional security mechanisms other than the at least one security mechanism applied to the received data packet.

19. A method for securing a communication network, the method comprising the steps of:
receiving a data packet;
determining if a security indicator is present in the received data packet;
applying at least one security mechanism to the received data packet upon determining that the security indicator is not present; and
refraining from applying security to the received data packet upon determining that the security indicator is present.

20. A method as defined in claim 19, wherein receiving the data packet comprising receiving the data packet over a nested connection.

21. A method as defined in claim 19, wherein determining if the security indicator is present further comprises determining if at least one of authentication, integrity protection and encryption are present in the received data packet.

22. A method as defined in claim 19, wherein the security indicator comprises a plurality of values, wherein each of a plurality of security mechanisms corresponds to one of the plurality of values.

23. A method as defined in claim 19, wherein applying the at least one mechanism comprises applying at least one of authentication, integrity protection and encryption to the received data packet.

24. A second network node for securing a communication network, the second network node comprising:
an input for receiving a data packet;
a security detector so configured as to detect a security indicator in the received data packet; and
a security application module responsive to the security detector for applying security to the received data packet upon detecting absence of the security indicator and for refraining from applying security in the received data packet upon detection of the security indicator.

25. A second network node as defined in claim 24, wherein the input receives the data packet over a nested connection.

26. A second network node as defined in claim 24, wherein the security detector further detects if at least one of authentication, integrity protection and encryption is present in the received data packet.

27. A second network node as defined in claim 24, wherein the security indicator comprises a plurality of values, wherein each of a plurality of security mechanisms corresponds to one of the plurality of values.

28. A second network node as defined in claim 27, wherein the security indicator comprises at least one of the plurality of values in accordance with the step of applying at least one security mechanism to the data packet.
